(19) United States
(12) Patent Application Publication
(10) Pub. No.: US 2018/0073694 A1
(43) Pub. Date: Mar. 15, 2018

(54) LIGHT DIFFUSING DEVICE FOR CHARGER WITH NIGHT LIGHT

(71) Applicant: SHENZHEN YUSHUOXIN ELECTRONICS CO., LTD, SHENZHEN (CN)

(72) Inventor: LAN TONG, HUIZHOU (CN)

(21) Appl. No.: 15/437,071

(22) Filed: Feb. 20, 2017

(30) Foreign Application Priority Data
Sep. 14, 2016 (CN) 201621057075.4

(51) Int. Cl. F21S 8/00; F21V 3/00; F21V 7/07; F21V 23/06; F21V 23/02; F21V 23/04; H02J 7/00

(52) U.S. Cl. CPC F21S 8/035; F21V 3/00; F21V 7/07; F21V 23/06; F21Y 2105/10; F21V 23/0471; H02J 7/0045; H02J 7/0052; F21V 23/02

(57) ABSTRACT

A light diffusing device for a charger with smart night light is provided, including a light-emitting component, a sensor light disposed on the light-emitting component, a trumpet-shaped reflector and a light-permeable upper housing. The reflector is provided on the light-emitting component, the sensor light is disposed in a trumpet-shaped interior chamber of the reflector, LED lamp beads are disposed on the light-emitting component and surround the sensor light, lights from the LED lamp beads are emitted to a rear face of the reflector, and the light-permeable upper housing is provided on the light-emitting component and the reflector. Light emitted from each LED lamp bead is a point light source and a direct light, and is scattered by the rear face of the reflector and then projected through the upper housing, such that the irradiation range is widened and the light is diffused towards the surroundings.

### BACKGROUND

### 1. Technical Field

The present disclosure relates to the technical field of a charger, in particular, to a light diffusing device for a charger with smart night light.

### 2. Description of Related Art

Because of the rapid development of mobile terminals and electronic equipment, chargers have gradually become indispensable to daily life. Most chargers are designed for charging, but some chargers are further equipped with other functions such as lighting, Wi-Fi and so on. With the mature technology in the field of LED, a majority of chargers are disposed with LED light-emitting elements to emit light. However, light emitted from the LED light-emitting element is a point light source and its ray is a direct light and not soft enough, resulting in the poor lighting effect on the surroundings. Conventionally, light diffusing plates are used to enhance the lighting effect, and the LED lamp beads are arranged based on the light exposure direction. Nonetheless, in such case the production cost is inevitably increased and the lighting effect is not effectively improved.

### SUMMARY

The primary purpose of the present disclosure is to provide a light diffusing device for a charger with smart night light capable of widening the irradiation range, diffusing light towards the surroundings and enabling the light to be soft, as well as reducing the production cost.

In order to accomplish the above-mentioned purpose, the present disclosure is implemented by the following technical solutions.

A light diffusing device for a charger with smart night light of the present disclosure is provided, including a light-emitting component, a sensor light disposed on the light-emitting component, a trumpet-shaped reflector and a light-permeable upper housing. The reflector is fixedly mounted on the light-emitting component, the sensor light is disposed in a trumpet-shaped interior chamber of the reflector through a center hole of the reflector, a plurality of LED lamp beads are disposed on the light-emitting component and surround the sensor light, lights from the plurality of LED lamp beads are emitted to a rear face of the reflector, and the light-permeable upper housing is provided on the light-emitting component and the reflector.

The light diffusing device for a charger with smart night light of the present disclosure further includes a lower housing and a plug clamping to the lower housing, wherein the lower housing clamps to the upper housing, a voltage conversion module and a control module are disposed in the lower housing, the control module is connected to the voltage conversion module, and the voltage conversion module is connected to the light-emitting component.

A charging port is provided at a side of the lower housing, and the charging port is connected to the voltage conversion module.

The sensor light is a pyroelectric infrared sensor.

The charging port is a USB port.

The light-emitting component is a LED light plate.

Compared to its conventional counterparts, the present disclosure has the following advantages.

Light emitted from each LED lamp bead is a point light source and its ray is a direct light, and the light emitted from each LED lamp bead is scattered by the rear face of the reflector and then projected through the upper housing, such that the irradiation range is widened and the light is diffused towards the surroundings and becomes soft. In addition, the production cost can be reduced.

Relative to conventional light-focusing torches, a light diffusing device for a charger with smart night light of the present disclosure diffuses the light from an external part of the trumpet-shaped reflector towards the surroundings, such that the irradiation range is widened and the light becomes soft. Most chargers are equipped with night-light function, and the charger provided by the present disclosure is further disposed with human body detection mechanisms such as a pyroelectric infrared sensor to detect whether to turn on the night light according to the user need so as to save power without affecting the user's sleep.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram illustrating the structure of the present disclosure.

FIG. 2 is an explosion diagram of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

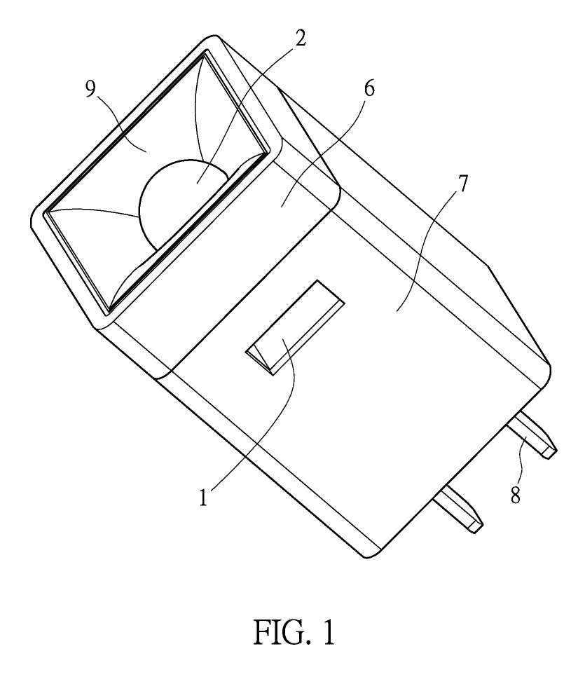

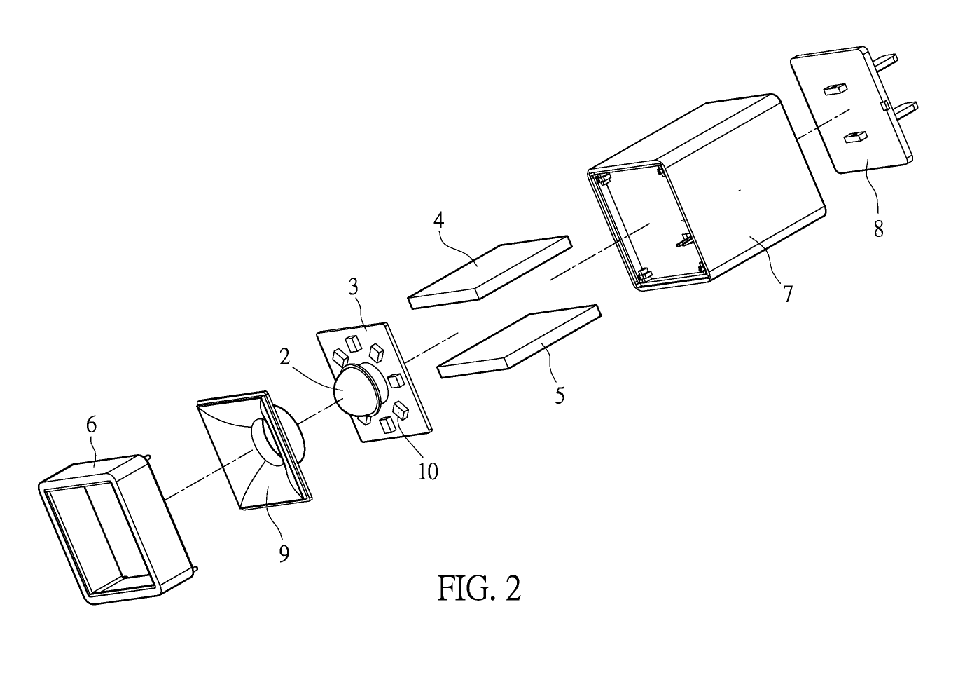

As shown in FIG. 1 and FIG. 2, a light diffusing device for a charger with smart night light of the present disclosure includes a light-emitting component 3, a sensor light 2 disposed on the light-emitting component 3 and a trumpet-shaped reflector 9, wherein the reflector 9 is fixedly mounted on the light-emitting component 3, the sensor light 2 is disposed in a trumpet-shaped interior chamber of the reflector 9 through a center hole of the reflector 9, a plurality of LED lamp beads 10 are disposed on the light-emitting component 3 and surround the sensor light 2, lights from the plurality of LED lamp beads 10 are emitted to a rear face of the reflector 9, and a light-permeable upper housing 6 is provided on the light-emitting component 3 and the reflector 9.

The present disclosure further includes a lower housing 7 and a plug 8 clamping to the lower housing 7. The lower housing 7 clamps to the upper housing 6. A voltage conversion module 5 and a control module 4 are disposed in the lower housing 7, the control module 4 is connected to the voltage conversion module 5, and the voltage conversion module 5 is connected to the light-emitting component 3.

A charging port 1 is provided at a side of the lower housing 7, and the charging port 1 is connected to the voltage conversion module 5.

The sensor light 2 is a pyroelectric infrared sensor.

The charging port 1 is a USB port.

The light-emitting component 3 is a LED light plate.

Compared to its conventional counterparts, the present disclosure has the following advantages.

Light emitted from each LED lamp bead 10 is a point light source and its ray is a direct light, and the light emitted from each LED lamp bead 10 is scattered by the rear face of the reflector 9 and then projected through the upper housing 6, such that the irradiation range is widened and the light is diffused towards the surroundings and becomes soft. In addition, the production cost can be reduced.

Relative to conventional light-focusing torches, a light diffusing device for a charger with smart night light of the present disclosure diffuses the light from an external part of the trumpet-shaped reflector towards the surroundings, such that the irradiation range is widened and the light becomes soft. Most chargers are equipped with night-light function, and the charger provided by the present disclosure is further disposed with human body detection mechanisms such as a pyroelectric infrared sensor to detect whether to turn on the night light according to the user need so as to save power without affecting the user's sleep.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A light diffusing device for a charger with smart night light, comprising: a light-emitting component, a sensor light disposed on the light-emitting component, a trumpet-shaped reflector and a light-permeable upper housing, wherein the reflector is fixedly mounted on the light-emitting component, the sensor light is disposed in a trumpet-shaped interior chamber of the reflector through a center hole of the reflector, a plurality of LED lamp beads are disposed on the light-emitting component and surround the sensor light, lights from the plurality of LED lamp beads are emitted to a rear face of the reflector, and the light-permeable upper housing is provided on the light-emitting component and the reflector.

2. The light diffusing device for a charger with smart night light according to claim 1, further comprising: a lower housing and a plug clamping to the lower housing, wherein the lower housing clamps to the upper housing, a voltage conversion module and a control module are disposed in the lower housing, the control module is connected to the voltage conversion module, and the voltage conversion module is connected to the light-emitting component.

3. The light diffusing device for a charger with smart night light according to claim 2, wherein a charging port is provided at a side of the lower housing, and the charging port is connected to the voltage conversion module.

4. The light diffusing device for a charger with smart night light according to claim 3, wherein the charging port is a USB port.

5. The light diffusing device for a charger with smart night light according to claim 1, wherein the sensor light is a pyroelectric infrared sensor.

6. The light diffusing device for a charger with smart night light according to claim 1, wherein the light-emitting component is a LED light plate.
